(19) United States
(12) Patent Application Publication
(10) Pub. No.: US 2026/0048536 A1
(43) Pub. Date: Feb. 19, 2026

(54) DETERMINATION METHOD, SHAPING METHOD, ARTICLE MANUFACTURING METHOD, INFORMATION PROCESSING APPARATUS, AND SHAPING APPARATUS

(71) Applicant: CANON KABUSHIKI KAISHA, Tokyo (JP)

(72) Inventors: SENTARO AIHARA, Tochigi (JP); YUICHIRO OGUCHI, Tokyo (JP)

(21) Appl. No.: 19/293,127

(22) Filed: Aug. 7, 2025

(30) Foreign Application Priority Data
Aug. 13, 2024 (JP) 2024-135035

(51) Int. Cl. B29C 43/58; B29C 37/00; B29C 43/18

(52) U.S. Cl. CPC B29C 43/58; B29C 37/00; B29C 43/18; B29C 2037/903

(57) ABSTRACT

The present disclosure provides a determination method of a control profile used to temporally control a mechanism configured to be operated in a shaping process of shaping a composition on a substrate using a mold, the method comprising: obtaining a processing condition used for the shaping process; adjusting one or more elements, that define a function representing the control profile using an elapsed time of the shaping process as a variable, such that an evaluation value concerning a state of the composition in a case where the shaping process is performed under the processing condition falls within a predetermined range; and determining the control profile based on the adjusted one or more elements.

### BACKGROUND

### Field of the Technology

The present disclosure relates to a determination method, a shaping method, an article manufacturing method, an information processing apparatus, and a shaping apparatus.

### Description of the Related Art

There is known a shaping technique (shaping process) of shaping a composition on a substrate by bringing the composition arranged on the substrate and a mold into contact with each other. Such a shaping technique is applicable to an imprint apparatus and a planarization apparatus. The imprint apparatus uses a mold having a contact surface including a concave-convex pattern, and the pattern of the mold is transferred to a composition on a substrate by curing the composition in a state in which the composition on the substrate and the contact surface are in contact with each other. The planarization apparatus uses a mold having a flat contact surface, and a film of a composition having a flat surface is formed on a substrate by curing the composition in a state in which the composition on the substrate and the contact surface are in contact with each other.

In the shaping technique, for example, in an operation of bringing the mold and the composition on the substrate into contact with each other, a pressing force for pressing the mold against the composition on the substrate, a pressure (a so-called cavity pressure) for bulging the contact surface of the mold toward the substrate, and the like are temporally controlled in accordance with a predetermined control profile. Japanese Patent No. 5433584 describes that in an imprint process, the pressing force and the cavity pressure are controlled based on the height profile between a mold (template) and a substrate.

In the shaping process, if the control profile is not set appropriately, a shaping defect of the composition can occur. For example, when the mold and the composition on the substrate are brought into contact with each other, a bubble may remain between the mold and the substrate (that is, in the composition on the substrate) and a defect (unfilled defect) can occur in the location where the bubble exists. Since the tendency for the shaping defect to occur can change in accordance with the condition for the shaping process, it is necessary to determine the control profile every time the condition for the shaping process is changed. Hence, a technique for appropriately and easily determining the control profile is desired.

### SUMMARY

The present disclosure provides a technique advantageous in appropriately and easily determining a control profile used in a shaping process.

According to one aspect of the present disclosure, there is provided a determination method of a control profile used to temporally control a mechanism configured to be operated in a shaping process of shaping a composition on a substrate using a mold, the method comprising: obtaining a processing condition used for the shaping process; adjusting one or more elements, that define a function representing the control profile using an elapsed time of the shaping process as a variable, such that an evaluation value concerning a state of the composition in a case where the shaping process is performed under the processing condition falls within a predetermined range; and determining the control profile based on the adjusted one or more elements.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are views showing an example of the arrangement of an imprint apparatus;

FIG. 2 is a view showing an example of the configuration of a system for determining a control profile;

FIG. 3 is a view showing an example of the hardware arrangement of a server apparatus that determines the control profile;

FIG. 4 is a flowchart illustrating a determination method of the control profile;

FIGS. 5A to 5C are views each showing a simulation result of the distribution of defects generated in an imprint material on a substrate by an imprint process;

FIG. 6 is a view showing the bubble defect density at each time in a contact operation;

FIG. 7 is a view for explaining a determination method using an evaluation value;

FIGS. 8A to 8D are views each showing an example of the control profile used in the imprint process;

FIG. 9 is a view showing an example of the graph shape of the control profile;

FIG. 10 is a view showing an example of the graph shape of the control profile;

FIG. 11 is a view showing an example of the graph shape of the control profile;

FIG. 12 is a view showing an example of the graph shape of the control profile;

FIG. 13 is a view showing an example of the graph shape of the control profile;

FIG. 14 is a view showing an example of the graph shape of the control profile;

FIG. 15 is a view showing an example of updating a parameter value using Bayesian optimization; and

FIGS. 16A to 16F are views for explaining an article manufacturing method.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the specification and the accompanying drawings, directions will be indicated on an XYZ coordinate system in which a plane parallel to the surface for holding a substrate (for example, the upper surface of a substrate holder) is defined as the X-Y plane, unless otherwise specified. Directions parallel to the X-axis, the Y-axis, and the Z-axis of the XYZ coordinate system are the X direction, the Y direction, and the Z direction, respectively. A rotation about the X-axis, a rotation about the Y-axis, and a rotation about the Z-axis are θX, θY, and θZ, respectively. Control or driving concerning the X-axis, the Y-axis, and the Z-axis means control or driving concerning a direction parallel to the X-axis, a direction parallel to the Y-axis, and a direction parallel to the Z-axis, respectively. In addition, control or driving concerning the θX-axis, the θY-axis, and the θZ-axis means control or driving concerning a rotation about an axis parallel to the X-axis, a rotation about an axis parallel to the Y-axis, and a rotation about an axis parallel to the Z-axis, respectively. In addition, a position is information that can be specified based on coordinates on the X-, Y-, and Z-axes, and a posture is information that can be specified by values on the θX-, θY-, and θZ-axes.

A shaping apparatus according to the present disclosure is an apparatus that performs a shaping process of shaping a composition on a substrate using a mold. Examples of the shaping apparatus are an imprint apparatus and a planarization apparatus. The imprint apparatus is an apparatus that brings a mold including a concave-convex pattern (i.e., a pattern having concave and convex portions) into contact with a composition (imprint material) on a substrate to form (transfer) the pattern in the composition. The shaping process performed by the imprint apparatus is sometimes called an imprint process. The planarization apparatus is an apparatus that planarizes the surface of a composition by bringing a mold having a flat surface into contact with the composition on a substrate. In the mold used in the planarization apparatus, 90% or more (preferably 95% or more) of the contact surface that comes into contact with the composition on the substrate can be formed as a flat surface in which no concave-convex pattern is formed. The shaping process performed by the planarization apparatus is sometimes called a planarization process. In the following description, the imprint apparatus will be exemplified as the shaping apparatus, but arrangements/processes of the imprint apparatus can also be applied to the planarization apparatus.

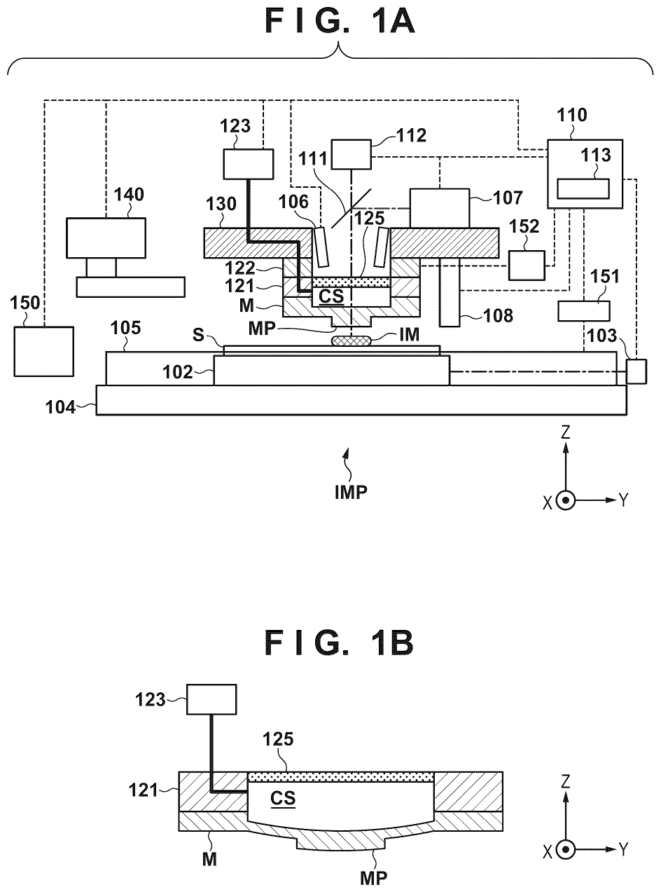

An imprint apparatus IMP as an embodiment according to the present disclosure will be described. FIG. 1A is a schematic view showing an example of the arrangement of the imprint apparatus IMP according to this embodiment. The imprint apparatus IMP is an apparatus that brings a mold and an imprint material (composition) supplied onto a substrate into contact with each other, and applies curing energy to the imprint material, thereby forming a pattern of a cured product to which the concave-convex pattern of the mold has been transferred. For example, the imprint apparatus IMP supplies a liquid imprint material IM as a plurality of droplets onto a substrate S, and cures the imprint material in a state in which a mold M (mold) formed with a concave-convex pattern is in contact with the imprint material IM on the substrate S. Then, the imprint apparatus IMP increases the spacing between the mold M and the substrate S to separate the mold M from the cured imprint material IM. Thus, the pattern of the mold M can be transferred to the imprint material IM on the substrate S. Such a series of processes is called an “imprint process”, and is performed for each of a plurality of shot regions of the substrate S.

As the imprint material IM, a curable composition (to be also referred to as a resin in an uncured state) to be cured by receiving curing energy is used. As the curing energy, an electromagnetic wave, heat, or the like can be used. The electromagnetic wave can be, for example, light selected from the wavelength range of 10 nm (inclusive) to 1 mm (inclusive), for example, infrared light, visible light, or ultraviolet light. The curable composition can be a composition cured by light irradiation or heating. Among these, the photo-curable composition cured by light irradiation contains at least a polymerizable compound and a photopolymerization initiator, and may further contain a nonpolymerizable compound or a solvent, as needed. The nonpolymerizable compound is at least one type of material selected from a group consisting of a sensitizer, a hydrogen donor, an internal mold release agent, a surfactant, an antioxidant, a polymer component, and the like. The imprint material IM can be arranged on the substrate S in a droplet shape or in an island or film shape formed by connecting a plurality of droplets. The viscosity (the viscosity at 25° C.) of the imprint material IM can be, for example, 1 mPa's (inclusive) to 100 mPa·s (inclusive). As the material of the substrate S, for example, glass, a ceramic, a metal, a semiconductor, a resin, or the like can be used. A member made of a material different from that of the substrate S may be provided on the surface of the substrate S, as needed. The substrate S is, for example, a silicon wafer, a compound semiconductor wafer, or silica glass.

The imprint apparatus IMP can include a substrate holder 102 that holds the substrate S, a substrate driving mechanism 105 that drives the substrate S by driving the substrate holder 102, a base 104 that supports the substrate holder 102, and a position measurement unit 103 that measures the position of the substrate holder 102. The substrate driving mechanism 105 can include, for example, a motor such as a linear motor. The imprint apparatus IMP can include a sensor 151 that detects the substrate driving force (alignment load) required for the substrate driving mechanism 105 to drive the substrate S (substrate holder 102) during alignment between the mold M and the substrate S. The substrate driving force in an alignment operation, which is performed in a state in which the imprint material IM on the substrate S and a pattern region MP of the mold M are in contact with each other, corresponds to, for example, a shear force that acts between the substrate S and the mold M. The shear force is a force that acts mainly in the plane direction (X and Y directions) of the substrate S and the mold M. The substrate driving force during alignment is, for example, correlated to the magnitude of a current supplied to the motor of the substrate driving mechanism 105 during alignment. The sensor 151 can detect the substrate driving force based on the magnitude of the current. The sensor 151 is an example of the sensor for measuring the influence (shear force) received by the mold M during the pattern formation.

The imprint apparatus IMP can include a mold holder 121 that holds the mold M (mold), a mold driving mechanism 122 that drives the mold M by driving the mold holder 121, and a support structure 130 that supports the mold driving mechanism 122. The mold driving mechanism 122 can include, for example, a motor such as a voice coil motor. The imprint apparatus IMP can include a sensor 152 that detects a pressing force and/or a mold separation force (separation load). The pressing force is a force of pressing the mold M against the imprint material IM on the substrate S to bring the mold M and the imprint material IM on the substrate S into contact with each other. The mold separation force is a force required to separate the cured product of the imprint material IM on the substrate S and the mold M from each other. The pressing force and the mold separation force are forces that act mainly in a direction (Z direction) perpendicular to the plane direction of the substrate S and the mold M. Each of the pressing force and the mold separation force is, for example, correlated to the magnitude of the current supplied to the motor of the mold driving mechanism 122. The sensor 152 can detect the pressing force and the mold separation force based on the magnitude of the current. The sensor 152 is an example of the sensor for measuring the influence (the pressing force and/or the mold separation force) received by the mold M during the pattern formation.

The substrate driving mechanism 105 and the mold driving mechanism 122 form a driving mechanism that adjusts the relative position and relative posture between the substrate S and the mold M. Adjustment of the relative position between the substrate S and the mold M by the driving mechanism includes driving for bringing the mold M into contact with the imprint material IM on the substrate S and driving for separating the mold M from the cured imprint material IM (the pattern of a cured product). The substrate driving mechanism 105 can be configured to drive the substrate S with respect to a plurality of axes (for example, three axes including the X-axis, Y-axis, and θZ-axis, and preferably six axes including the X-axis, Y-axis, Z-axis, θX-axis, θY-axis, and θZ-axis). The mold driving mechanism 122 can be configured to drive the mold M with respect to a plurality of axes (for example, three axes including the Z-axis, θX-axis, and θY-axis, and preferably six axes including the X-axis, Y-axis, Z-axis, θX-axis, θY-axis, and θZ-axis).

The mold holder 121 can include a window member 125 for forming a pressure control space CS on the side of the back surface (the surface on the opposite side of the pattern region MP where the pattern to be transferred to the substrate S is formed) of the mold M. The imprint apparatus IMP can include a deformation mechanism 123 that deforms the pattern region MP of the mold M into a convex shape toward the substrate S as schematically shown in FIG. 1B by controlling the pressure (to be sometimes referred to as the “cavity pressure” hereinafter) in the pressure control space CS. For example, when the mold M is deformed into a convex shape in a contact operation of bringing the mold M into contact with the imprint material IM on the substrate S, the mold M (pattern region MP) can gradually be brought into contact with the imprint material IM on the substrate S, thereby reducing confinement of a gas in the concave portions of the pattern of the mold M. That is, unfilling of the imprint material IM into the pattern of the mold M can be reduced. Also, when the mold M is deformed into a convex shape in a mold separation operation of separating the mold M from the cured product of the imprint material IM on the substrate S, breakage of the pattern made of the cured product of the imprint material IM formed on the substrate S can be reduced. Note that the cavity pressure may be understood as a force (deformation force) applied to the mold M to deform the mold M into a convex shape.

The imprint apparatus IMP can include a mold conveyance mechanism 140 that conveys the mold M, and a mold cleaner 150. The mold conveyance mechanism 140 can be configured to, for example, convey the mold M to the mold holder 121 and convey the mold M from the mold holder 121 to an original stocker (not shown), the mold cleaner 150, or the like. The mold cleaner 150 cleans the mold M using ultraviolet light, a chemical solution, or the like.

The imprint apparatus IMP can include an alignment measurement device 106. The alignment measurement device 106 illuminates an alignment mask on the substrate S and an alignment mark on the mold M and captures images of these alignment marks, thereby measuring the relative position between the marks. The imprint apparatus IMP is provided with a plurality of alignment measurement devices 106, and can simultaneously observe a plurality of alignment marks formed in the shot region of the substrate S and the mold M by the plurality of alignment measurement devices 106. For example, the imprint apparatus IMP can be provided with four alignment measurement devices 106 for observing alignment marks formed at four corners of each of the shot region of the substrate S and the mold M. The alignment measurement device 106 can be positioned by a driving mechanism (not shown) in accordance with the positions of alignment marks to be observed. An image captured by the alignment measurement device 106 will be referred to as an alignment image hereinafter, and an alignment mark position measured by the alignment measurement device 106 will be referred to as an alignment measurement value hereinafter. An example of the alignment image obtained by the alignment measurement device 106 is an image obtained by capturing (detecting) reflected light from each alignment mark of the substrate S and the mold M. Alternatively, the alignment image may be an image obtained by capturing (detecting) an image formed by moiré of each alignment mark of the substrate S and the mold M.

The imprint apparatus IMP can include a curing unit 107, an image capturing unit 112, and an optical member 111 (beam splitter). The curing unit 107 irradiates the imprint material IM on the substrate S with energy (for example, light such as ultraviolet light) for curing the imprint material IM via the optical member 111, thereby curing the imprint material IM. The image capturing unit 112 captures images of the substrate S, the mold M, and the imprint material IM on the substrate S via the optical member 111 and the window member 125. Note that an image captured by the image capturing unit 112 may be referred to as a spread image.

The imprint apparatus IMP can include a dispenser 108 that arranges (supplies) the imprint material IM as a plurality of droplets on the substrate S. For example, the dispenser 108 discharges the imprint material IM such that the imprint material IM is arranged as a plurality of droplets on the substrate S in accordance with an arrangement pattern indicating the arrangement of the droplets of the imprint material IM.

The imprint apparatus IMP can include a controller 110 that controls the substrate driving mechanism 105, the mold driving mechanism 122, the deformation mechanism 123, the mold conveyance mechanism 140, the mold cleaner 150, the alignment measurement device 106, the curing unit 107, the image capturing unit 112, the dispenser 108, and the like. The controller 110 can include, as an arithmetic apparatus 113, for example, an information processing apparatus (computer) including a processor such as a Central Processing Unit (CPU) and a memory. Alternatively, the controller 110 may include, as the arithmetic apparatus 113, for example, an PLD (the abbreviation of Programmable Logic Device) such as an FPGA (the abbreviation of Field Programmable Gate Array), an ASIC (the abbreviation of Application Specific Integrated Circuit), a general-purpose computer incorporating a program, or a combination of some or all of these.

This embodiment has as its object to determine a control profile used to temporally control a mechanism (to be sometimes referred to as an operation mechanism hereinafter) operated in an imprint process (shaping process) of the imprint apparatus IMP. The imprint process includes a contact operation (pressing operation) of bringing the mold M into contact with the imprint material IM on the substrate S, and a mold separation operation of separating the mold M from the cured product of the imprint material IM on the substrate S, and can be performed by operating a plurality of kinds of operation mechanisms. The plurality of kinds of operation mechanisms can include, for example, the substrate driving mechanism 105 that drives the substrate S, the mold driving mechanism 122 that drives the mold M, and the deformation mechanism 123 that controls the pressure (cavity pressure) in the pressure control space CS.

The control profile is a profile indicating the temporal driving target value of each operation mechanism in the imprint process, and the driving target value can change as time elapses. The control profile can influence the state of the imprint material IM (for example, defects generated in the film of the imprint material IM, the shape (thickness) of the film, and the like) on the substrate S shaped by the imprint process. It is difficult to detect such the state of the imprint material IM based only on information obtained from the sensor in the imprint apparatus IMP. In addition, since the state of the imprint material IM (for example, the tendency for the defect to occur) can change in accordance with the processing condition used for the imprint process, it is necessary to determine the control profile every time the processing condition is changed. Hence, a technique for appropriately and easily determining the control profile is desired. This embodiment provides a method of more efficiently adjusting one or more elements that define a function representing the control profile using the elapsed time of the imprint process as a variable. Note that the one or more elements can include at least one of a coefficient and a constant that define the function representing the control profile, and may be referred to as “one or more parameter values” below.

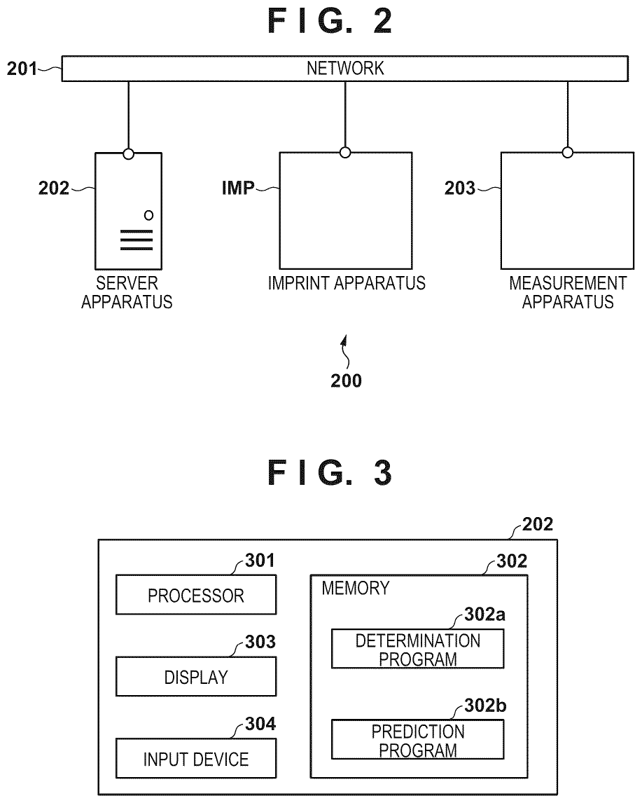

FIG. 2 shows an example of the configuration of a system 200 for determining a control profile. The system 200 can include the imprint apparatus IMP, a server apparatus 202, and a measurement apparatus 203. These apparatuses can transmit and receive information and data via a network 201. For example, information and data required by the server apparatus 202 can be provided to the server apparatus 202 via the network 201.

The server apparatus 202 is an apparatus (optimization server) for determining a control profile used to temporally control each operation mechanism of the imprint apparatus IMP, and can include a program for determining the control profile by adjusting one or more parameter values. The server apparatus 202 can be formed from, for example, an information processing apparatus (computer) including a processor such as a Central Processing Unit (CPU) and a memory. The control profile determined by the server apparatus 202 can be provided to the imprint apparatus IMP via the network 201. Here, in this embodiment, an example in which the control profile is determined by the server apparatus 202 will be described. However, the control profile is not limited to this, and may be determined by the controller 110 (arithmetic apparatus 113) of the imprint apparatus IMP.

The measurement apparatus 203 is an apparatus that measures (inspects) the state of the imprint material IM shaped on the substrate S by the imprint apparatus IMP. For example, the measurement apparatus 203 can measure, as the state of the imprint material IM, the positions and number of defects generated in the imprint material IM, the thickness of the imprint material IM, or the like. The measurement result of the measurement apparatus 203 can be provided to the server apparatus 202 via the network 201. Here, if the state of the imprint material IM is obtained (predicted) by simulation, the measurement apparatus 203 may not be provided in the system 200. The simulation can be executed by the server apparatus 202.

FIG. 3 shows an example of the hardware arrangement of the server apparatus 202 that determines the control profile. In the example shown in FIG. 3, the server apparatus 202 can include a processor 301, a memory 302, a display 303, and an input device 304. The processor 301 performs information processing for determining the control profile, and information processing for predicting (simulating) the state of the imprint material IM shaped on the substrate S by the imprint process. The memory 302 is a data read/write memory, and can be used to save programs and data. A determination program 302a for determining the control profile and a prediction program 302b for predicting (simulating) the state of the imprint material IM to be obtained by the imprint process are stored in the memory 302. The programs 302a and 302b are executed by the processor 301. The display 303 is an apparatus for displaying information required for the operation of the server apparatus 202, the result of information processing performed by the processor 301, and the like. An example of the display 303 is a Cathode Ray Tube (CRT), a liquid crystal monitor, or the like. The input device 304 is a device for the user to input characters and data to the server apparatus 202. Examples of the input device 304 include various kinds of keyboards and a mouse.

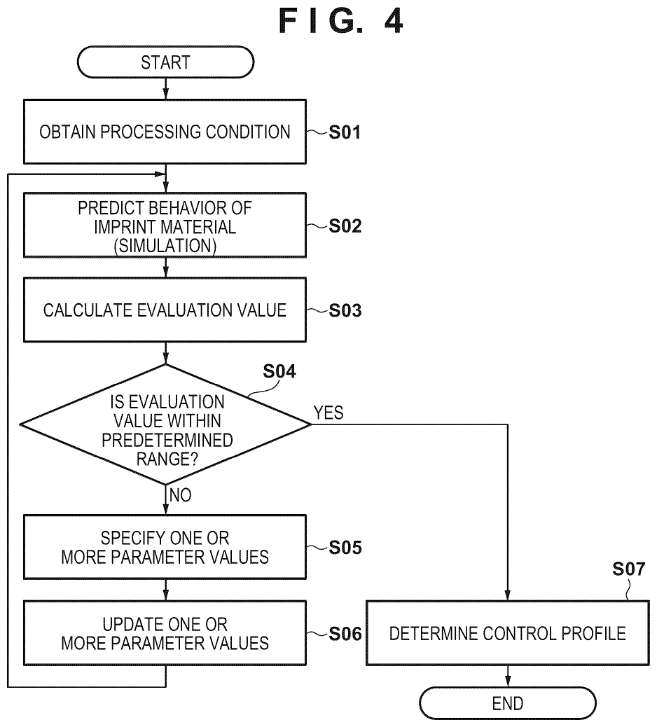

Next, a determination method of the control profile for each operation mechanism operated in the imprint process of the imprint apparatus IMP will be described. FIG. 4 is a flowchart illustrating the determination method of the control profile for each operation mechanism. If a plurality of kinds of operation mechanisms are operated in the imprint process of the imprint apparatus IMP, the flowchart of FIG. 4 is executed for each of the plurality of kinds of operation mechanisms. That is, the control profile is individually determined for each of the plurality of kinds of operation mechanisms.

Here, in this embodiment, an example will be described in which the flowchart of FIG. 4 is executed by the processor 301 of the server apparatus 202 in accordance with the determination program 302a. However, the flowchart of FIG. 4 may be executed by the controller 110 (arithmetic apparatus 113) of the imprint apparatus IMP. In addition, an example will be described in which the state of the imprint material IM to be obtained by the imprint process is predicted (simulated) by the processor 301 of the server apparatus 202 in accordance with the prediction program 302b, but the state may be measured using the measurement apparatus 203.

In step S01, the processor 301 obtains the processing condition used for the imprint process of the imprint apparatus IMP. The processing condition can include at least one of, for example, the density of the concave-convex pattern provided in the pattern region MP of the mold M, the depth of the concave portion (groove) of the concave-convex pattern, the target film thickness of the imprint material IM, and the arrangement of the imprint material IM supplied as a plurality of droplets onto the substrate S. The target film thickness of the imprint material IM may be understood as the thickness of the imprint material IM to be formed on the substrate S through the imprint process, that is, the thickness of the imprint material IM after formation (shaping) by the imprint process. The processor 301 may obtain the processing condition based on the information input by the user via the input device 304, or may obtain the processing condition based on the design data of the mold M, the target shape data of the imprint material, or the like.

Steps S02 to S06 are steps for adjusting one or more parameter values that define the function representing the control profile. In this embodiment, one or more parameter values are adjusted such that the evaluation value concerning the state of the imprint material IM in a case where the imprint process is performed under the processing condition obtained in step S01 falls within a predetermined range. Here, the type of the function representing the control profile is different among the plurality of kinds of operation mechanisms. One or more parameter values can be adjusted for each kind of the operation mechanism.

In step S02, the processor 301 executes, in accordance with the prediction program 302b, a simulation of predicting the behavior of the imprint material IM on the substrate S in a case where the imprint process is performed under the processing condition obtained in step S01. More specifically, the processor 301 simulates the imprint apparatus IMP, the mold M, the substrate S, the imprint material IM, and the environment in the apparatus, and sequentially operates each operation mechanism in the imprint apparatus IMP in accordance with the control profile. With this, as the result of the simulation, the state of the imprint material IM (for example, defects generated in the film of the imprint material IM, the shape and thickness of the film, or the like) corresponding to the elapsed time from the start of the imprint process can be predicted. Here, in step S02 for the first time, the simulation can be performed using the control profile (initial setting) set in advance for each operation mechanism. On the other hand, in step S02 for the second and subsequent times, the simulation can be performed using the control profile with one or more parameter values updated (changed) in step S06 (to be described later).

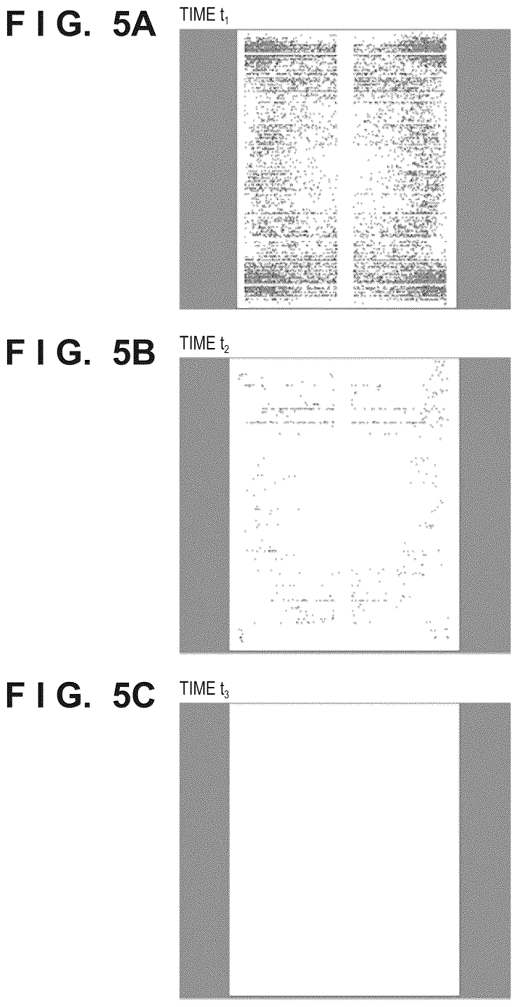

Each of FIGS. 5A to 5C shows, as the result of the simulation in step S02, the distribution of defects generated in the imprint material IM on the substrate S by the imprint process. Here, as the kind of the defect, a bubble defect generated when filling of the imprint material IM into the concave portion of the concave-convex pattern of the mold M is insufficient (for example, unfilling) is exemplified. FIGS. 5A to 5C show the temporal simulation results of the distribution of defects generated in the imprint material IM in the contact operation of the imprint process. FIG. 5A shows the distribution of defects at time t₁ in the early stage of the contact operation, FIG. 5B shows the distribution of defects at time t₂ after time t₁, and FIG. 5C shows the distribution of defects at time t₃ at the end of the contact operation. As shown in FIGS. 5A to 5C, at time t₁ in the early stage of the contact operation, there are bubble defects in the whole area of the shot region of the substrate S. At time t₂ when the contact operation has further progressed, the bubble defects have decreased. At time t₃ at the end of the contact operation, the bubble defects have further decreased, and there is almost no bubble.

Here, in step S02, in addition to or instead of the defects of the imprint material IM, the processor 301 can predict, as the state of the imprint material IM, the shape (thickness) of the imprint material IM or the position deviation of the pattern transferred to the imprint material IM. That is, as the state of the imprint material IM, the processor 301 can predict at least one of the defect of the imprint material IM, the shape of the imprint material IM, and the position deviation of the pattern of the imprint material IM, which are generated by the imprint process. The position deviation of the pattern of the imprint material IM may be understood as the position deviation between the mold M and the substrate S, that is, the difference between the target position on the substrate S where the pattern of the mold M should be transferred and the position on the substrate S where the pattern of the mold M is actually transferred.

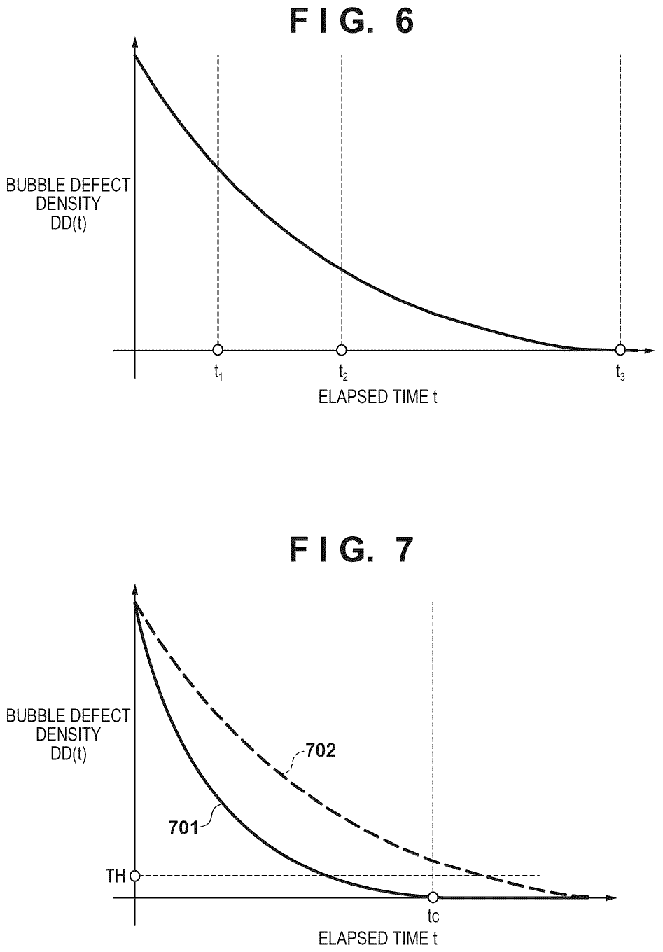

In step S03, the processor 301 calculates (obtains) the evaluation value concerning the state of the imprint material IM on the substrate S in the case where the imprint process is performed under the processing condition obtained in step S01. The processor 301 can calculate the evaluation value based on the simulation result obtained in step S02. For example, if the simulation concerning bubble defects is performed in step S02, the processor 301 can calculate the evaluation value based on the bubble defect density (the number of bubble defects per unit area). FIG. 6 shows the bubble defect density obtained from the simulation result at each of time t₁ to time t₃ in the contact operation, which is obtained in step S02. In FIG. 6, the abscissa represents elapsed time t from the start of the contact operation, and the ordinate represents a bubble defect density DD(t). The bubble defect density DD(t) shows a tendency to be lower at time t₂ than at time t₁ in the early stage of the contact operation, and lower at time t₃ at the end of the contact operation than at time t₂. The processor 301 can use, as the evaluation value, the value of the bubble defect density DD(t) at arbitrary time t. Alternatively, the processor 301 may use, as the evaluation value, the average value of the bubble defect densities DD(t) in a designated time range (for example, the range of time t₁ to time t₂) as expressed by the following equation (1).

$$evaluation value = \frac{{\int }_{t 1}^{t 2} DD ( t ) dt}{( t 2 - t 1 )} \qquad ( 1 )$$

Here, the example in which the evaluation value is calculated based on the bubble defect density DD(t) has been described in this embodiment, but the evaluation value is not limited to this. For example, in a case where the shape of the imprint material IM and/or the position deviation of the pattern of the imprint material IM is predicted in the simulation in step S02, the processor 301 may calculate the evaluation value based on these. Alternatively, the processor 301 may calculate the evaluation value based on a combination of at least two of the defect of the imprint material IM, the shape of the imprint material IM, and the position deviation of the pattern of the imprint material IM. That is, the processor 301 may calculate the evaluation value based on at least one of the defect of the imprint material IM, the shape of the imprint material IM, and the position deviation of the pattern of the imprint material IM, which are generated by the imprint process.

In this embodiment, the evaluation value is calculated based on the simulation result obtained in step S02, but the evaluation value is not limited to this. For example, the evaluation value may be calculated based on the actual result of the imprint process performed on a test substrate. In this case, in step S02, instead of the simulation, the imprint process is actually performed on a test substrate. Then, the defect of the imprint material IM, the shape of the imprint material IM, and/or the position deviation of the pattern of the imprint material IM on the test substrate is measured by the measurement apparatus 203. With this, in step S03, the processor 301 can obtain the information indicating the measurement result of the measurement apparatus 203 via the network 201, and calculate the evaluation value based on the measurement result.

In step S04, the processor 301 determines whether the evaluation value calculated in step S03 falls within the predetermined range. FIG. 7 is a view for explaining the determination method using the evaluation value. Here, an example will be described in which the value of the bubble defect density DD(t) at arbitrary time tc is used as the evaluation value. For example, as indicated by a graph shape 701, if the bubble defect density DD(t) at time tc is lower than a threshold TH, the processor 301 determines that the evaluation value falls within the predetermined range. In this case, the processor 301 advances to step S07. On the other hand, for example, as indicated by a graph shape 702, if the bubble defect density DD(t) at time tc is equal to or higher than the threshold TH, the processor 301 determines that the evaluation value falls outside the predetermined range. In this case, the processor 301 advances to step S05.

Here, in this embodiment, whether to update one or more parameter values in the control profile is determined in accordance with whether the evaluation value falls within the predetermined range. However, the present disclosure is not limited to this. For example, whether to update one or more parameter values in the control profile may be determined in accordance with whether the number of times of update of one or more parameter values has reached a predetermined number of times. Alternatively, whether to update one or parameter values in the control profile may be determined in accordance with whether the time required for updating one or more parameter values has reached a predetermined time.

In step S05, the processor 301 specifies (extracts) one or more parameter values that define the function representing the control profile. As described above, one or more parameter values are one or more elements that define the function representing the control profile using the elapse time of the imprint process as a variable, and can include at least one of a coefficient and a constant that define the function. The processor 301 can specify one or more parameter values for each control profile. For example, the processor 301 can specify one or more parameter values in the control profile in accordance with the kind of the operation mechanism for which the control profile is determined.

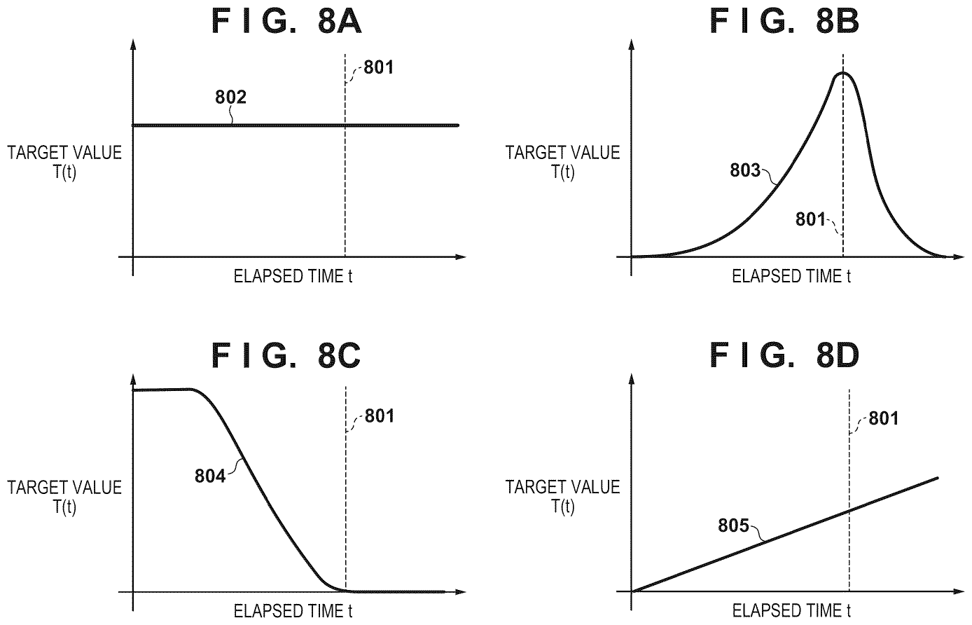

Each of FIGS. 8A to 8D shows an example of the control profile used in the imprint process. In each of FIGS. 8A to 8D, the abscissa represents the elapsed time t from the start of each operation of the imprint process, and the ordinate represents a target value T(t). The target value T(t) indicated on the ordinate in each of FIGS. 8A to 8D may be understood as a driving target value for each operation mechanism operated in the imprint process. For the contact operation, time 801 in FIGS. 8A to 8D indicates the timing when the mold M and the imprint material IM on the substrate S start to contact each other.

FIG. 8A shows a graph shape 802 of the control profile where the target value T(t) has a constant value regardless of the elapsed time t. As an example, the target position of the mold M in the Z direction when the mold M starts to contact the imprint material IM on the substrate S in the contact operation can be controlled using the control profile having the graph shape 802.

FIG. 8B shows a graph shape 803 of the control profile where the target value T(t) increases as the elapsed time t increases in the early stage, the target value T(t) reaches the maximum value around time 801, and the target value T(t) decreases from time 801. This graph shape 803 can be represented by, for example, a spline function or a nonlinear function. As an example, the target value of the pressing force applied to the mold M to press the mold M against the imprint material IM on the substrate S in the contact operation can be controlled using the control profile having the graph shape 803.

FIG. 8C shows a graph shape 804 of the control profile where the target value T(t) is constant in the early stage of the contact operation, the target value T(t) decreases thereafter, and the target value T(t) becomes constant around 0 from time 801. The graph shape 804 can be represented by, for example, an S-shaped function or a sigmoid function. As an example, the target value of the pressure (cavity pressure) applied to the pressure control space CS by the deformation mechanism 123 can be controlled using the control profile having the graph shape 804.

FIG. 8D shows a graph shape 805 of the control profile where the target value T(t) changes linearly as the elapsed time t increases. The graph shape 805 can be represented by, for example, a linear function. As an example, the driving amount of the mold M in the −Z direction from a reference position in the contact operation can be controlled using the control profile having the graph shape 805. In the mold separation operation, in order to gradually separate the mold M from the cured product of the imprint material IM on the substrate S from the center of the substrate S toward the outside, the holding region of the substrate S by the substrate holder 102 may be changed from the center of the substrate S toward the outside. In this case, the position of the substrate S (the distance from the centroid of the substrate S) held by the substrate holder 102 can be controlled using the control profile having the graph shape 805.

In this manner, the control profiles used in the imprint process are represented by various functions. As described above, examples of the various functions can include the function where the target value T(t) is constant with respect to the elapsed time t, the function where the target value T(t) changes linearly with respect to the elapsed time t, and the function where the target value T(t) changes nonlinearly (with a curve) with respect to the elapsed time t. The characteristics of the control parameters are not limited to the target position, velocity, and force, and may include a plurality of other characteristics such as the change amount per unit time of the target velocity, target acceleration, or the like.

As indicated by the control profiles shown in FIGS. 8A to 8D, each operation (for example, the contact operation or the mold separation operation) in the imprint process is performed in cooperation of a plurality of kinds of operation mechanisms, and the control profile can change along with the elapsed time t (time). Adjustment (determination) of the control profiles used to control various kinds of operation mechanisms as described above is conventionally performed by determining an optimum combination of the control profiles selected from a large number of control profile candidates that differ depending on the elapsed time and the operation mechanism, and this has been a work requiring enormous man-hours. To solve this problem, in this embodiment, one or more parameter values that define the function representing the control profile are specified, and the one or more parameter values are adjusted, thereby shortening the time required for the adjustment work of the control profile. That is, in this embodiment, since one or more parameter values that define the function representing the control profile are simply adjusted, the number of targets to be adjusted can be reduced, and as a result, the time required for adjusting the control profile can be shortened. Note that specifying one or more parameter values that define the function representing the control profile may be understood as approximating the control profile with a fewer finite number of parameter values.

A method of specifying and adjusting one or more parameter values for each type of the graph shape that the control profile can have will be described below.

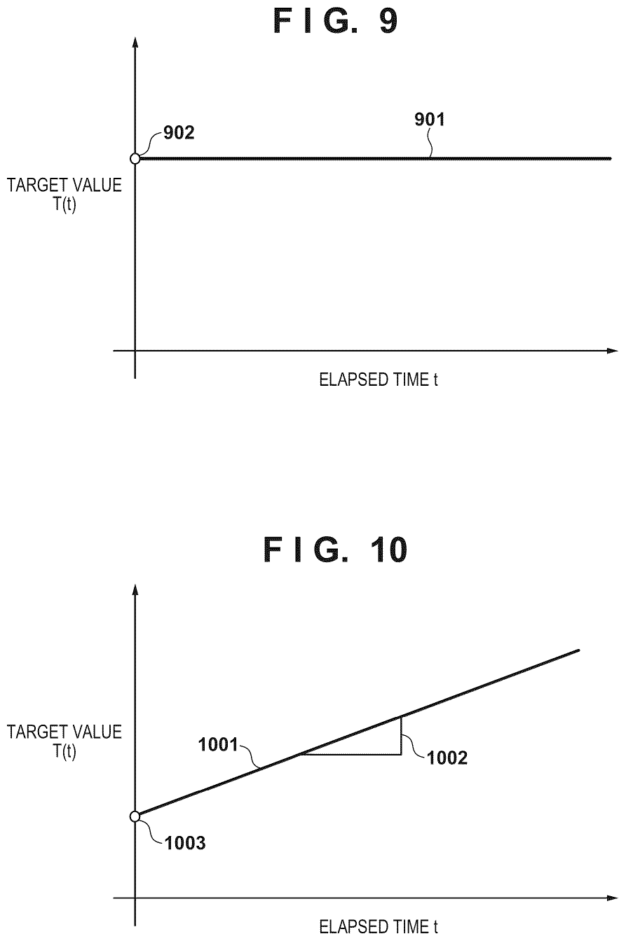

FIG. 9 shows a control profile having a graph shape 901 where the target value T(t) has a constant value 902 regardless of the elapsed time t. A function representing the control profile (graph shape 901) shown in FIG. 9 is defined by the following equation (2). In this case, a constant c in equation (2) is specified as one or more parameter values.

$$T ( t ) = c \qquad ( 2 )$$

FIG. 10 shows a control profile having a graph shape 1001 where the target value T(t) changes linearly with respect to the elapsed time t. A function representing the control profile (graph shape 1001) shown in FIG. 10 is defined by the following equation (3) where a coefficient a indicates a slope 1002 of the graph shape 1001, and a constant b indicates an intercept 1003 of the graph shape 1001. In this case, the coefficient a and the constant b in equation (3) are specified as one or more parameter values.

$$T ( t ) = at + b \qquad ( 3 )$$

FIG. 11 shows a control profile having a graph shape 1101 where the target value T(t) changes nonlinearly with respect to the elapsed time t. In the control profile (graph shape 1101) shown in FIG. 11, a function (first function) representing the first section where the elapsed time t ranges from 0 to tc is defined by the following equation (4), and a coefficient ax in each term indicates a slope 1102 of the graph shape 1101. In this case, the coefficient aₖ in each term in equation (4) is specified as one or more parameter values. In the control profile (graph shape 1101) shown in FIG. 11, a function (second function) representing the second section where the elapsed time t is from tc is defined by the following equation (5) expressing a function different from the first function, and a constant a₀ indicates an intercept 1103 of the graph shape 1101. In this case, the constant a₀ in equation (5) is specified as one or more parameter values. In this manner, the function different for each section of the control profile may be set, and one or more parameter values may be specified for each section.

$$T ( t ) = {a}_{n} {t}^{n} + {a}_{n - 1} {t}^{n - 1} + … {a}_{1} t + {a}_{0} \qquad ( 4 )$$

$$T ( t ) = {a}_{0} \qquad ( 5 )$$

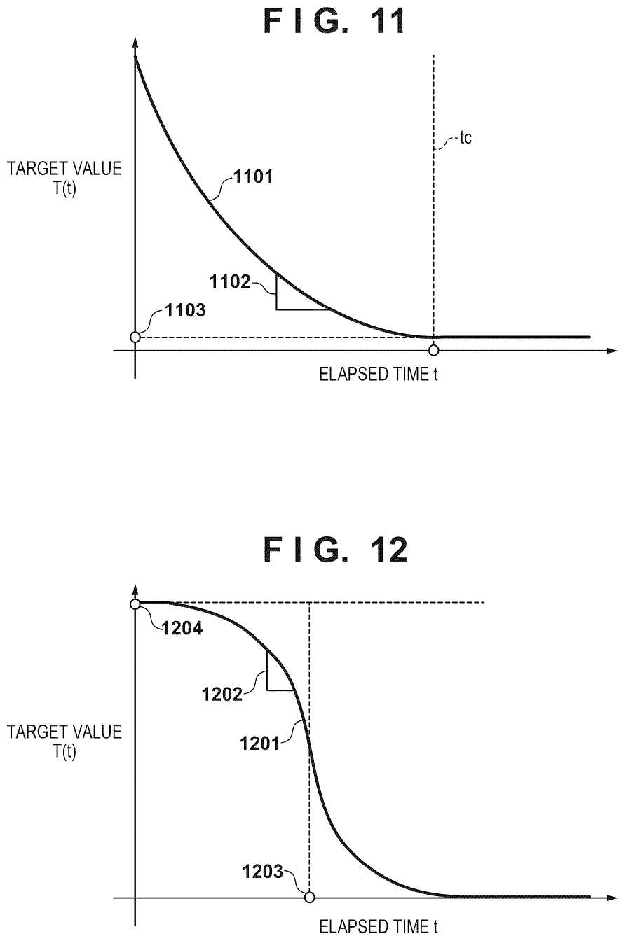

FIG. 12 shows a control profile having a graph shape 1201 where the target value T(t) changes according to an S-shaped curve with respect to the elapsed time t. A function representing the control profile (graph shape 1201) shown in FIG. 12 is defined by the following equation (6). In equation (6), the coefficient a indicates an intercept 1204 of the graph shape 1201, the constant b indicates an inflection point 1203 of the graph shape 1201, and a coefficient c indicates a slope 1202 of the graph shape 1201. In this case, the coefficient a, the constant b, and the coefficient c in equation (6) are specified as one or more parameter values.

$$T ( t ) = \frac{a}{1 + ( b - 1 ) \text{?}} \qquad ( 6 )$$

$$\text{?} \text{indicates text missing or illegible when filed}$$

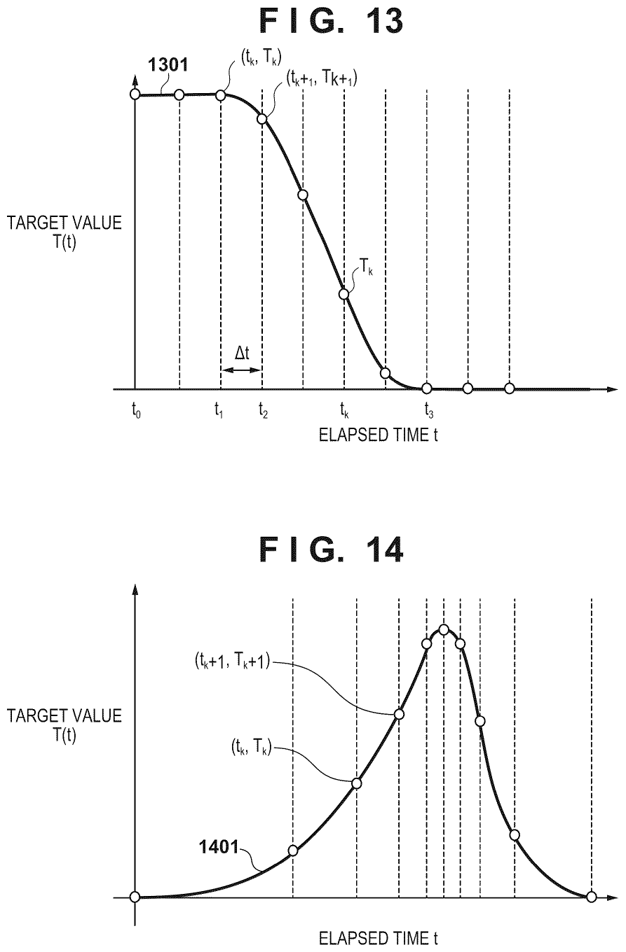

FIG. 13 shows a control profile having a graph shape 1301 where the target value T(t) changes according to a sigmoid curve with respect to the elapsed time t. The control profile (graph shape 1301) shown in FIG. 13 may be understood to have a different curved shape for each section of the elapsed time t, and a function representing the target value T(t) with respect to the elapsed time t is defined for each section of Δt. For example, in the control profile (graph shape 1301) shown in FIG. 13, a function representing the section where the elapsed time t ranges from t₁ to t₂ is defined by the following equation (7). In equation (7), “T₁” indicates the target value T(t) at time t₁, and “T₂” indicates the target value T(t) at time t₂. With this, the curve in the section where the elapsed time t ranges from t₁ to t₂ can be represented with fewer data. In this case, a combination of the elapsed time t and the target value T(t) for each section, that is, (t₀, T₀), (t₁, T₁), . . . , (tₙ, Tₙ) are specified as one or more parameter values.

$$T ( t ) = T 2 + \frac{( T 2 - T 1 )}{( t 2 - t 1 )} ( t - t 1 ) ( t 1 \leq t \leq t 2 ) \qquad ( 7 )$$

FIG. 14 shows a control profile having a graph shape 1401 where the target value T(t) increases as the elapsed time t increases, and then the target value T(t) decreases as the elapsed time t increases. The control profile (graph shape 1401) shown in FIG. 14 has a different curved shape for each section of the elapsed time t, and may be understood to be defined by spline interpolation. Spline interpolation is a method of generating a smooth line (path) by interpolating between two adjacent points using a cubic polynomial when a plurality of discrete points are given. For example, in the control profile (graph shape 1401) shown in FIG. 14, under a condition that the end point of the preceding section of two adjacent sections is connected to the start point of the subsequent section, and the slope at the end point of the preceding section and the slope at the start point of the subsequent section are the same, (n+1) discrete points are given. For (n+1) points including (t₀, T₀), . . . , (tₙ, Tₙ), a function (polynomial) that interpolates between a point (tₖ, Tₖ) and an adjacent point (tₖ₊₁, Tₖ₊₁) is defined by the following equation (8). In this case, for (n+1) points including (t₀, T₀), . . . , (tₙ, Tₙ), coefficients (a₀, b₀, c₀, d₀), . . . , (aₙ₋₁, bₙ₋₁, cₙ₋₁, dₙ₋₁) of polynomials each of which interpolates between two adjacent points are specified as one or more parameter values.

$${{T}_{k} ( t ) = {{a}_{k} ( t - {t}_{k} )}^{3} + {b}_{k} [ t - {t}_{k} )}^{2} + {c}_{k} ( t - {t}_{k} ) + {d}_{k} ( k = 0 ∼ n - 1 ) \qquad ( 8 )$$

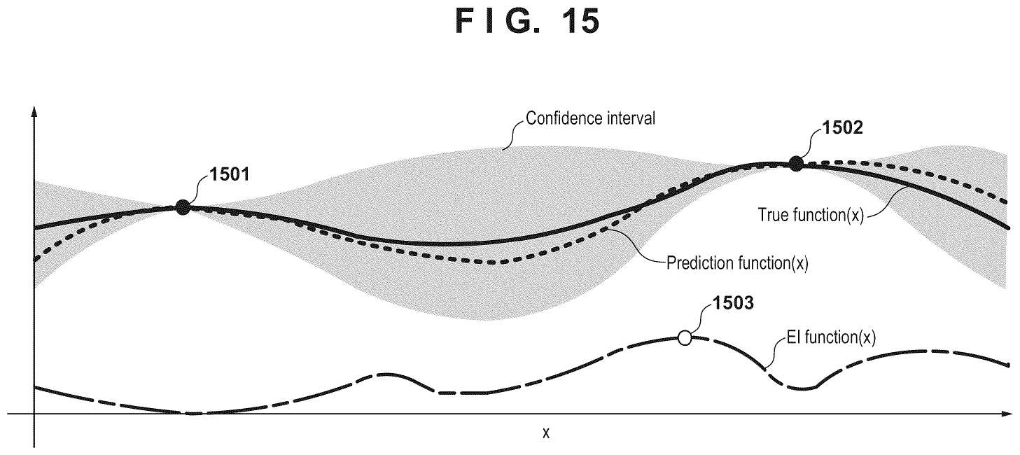

In step S06, the processor 301 updates (determines) one or more parameter values, which are specified in step S05 for the function representing the control profile, such that the evaluation value falls within the predetermined range. For example, the processor 301 can use Bayesian optimization to update one or more parameter values. FIG. 15 shows an example in which “x” indicates the parameter value, and the parameter value x is updated using Bayesian optimization. Note that the parameter value x may be understood as a combination of one or more parameter values.

In FIG. 15, a solid line True function (x) represents the true evaluation function when the evaluation value calculated in step S03 has the parameter value x as an argument. The desirable x value is the x value for which the true True function (x) has the optimal value, but the true True function (x) can be an unknown function. Therefore, the optimal x value is calculated by predicting the true evaluation function True function (x) using Gaussian process regression. As the procedure of Gaussian process regression, two points 1501 and 1502 in FIG. 15 are input to Gaussian process regression. As a result of the Gaussian process regression, a Prediction function (x), which is a prediction function of the evaluation function shown in FIG. 15, and a Confidence interval, which represents the likelihood of the prediction function for each point of the prediction function, are obtained. The prediction function Prediction function (x) obtained from Gaussian process regression is used to calculate an acquisition function EI, and the x value at a point 1503 where the acquisition function EI has the maximum value is determined as the updated parameter value x.

Here, other examples of the optimization method that can be used to update one or more parameter values are optimization algorithms such as CMA-ES (the abbreviation of Covariance Matrix Adaptation Evolution Strategy) and a Nelder-Mead method. In a case where the number of kinds of (the number of) one or more parameter values is small, CMA-ES can also use a method in which, evaluation values are calculated for all combinations of one or more parameter values, and a combination of one or more parameter values that gives the best evaluation value is used.

To update one or more parameter values in step S06 in this embodiment, the bubble defect density is used as the evaluation value. However, the operation behavior in the imprint process, such as the shape (thickness) of the film of the imprint material IM formed on the substrate S, the position deviation of the pattern transferred to the imprint material IM, or the spreading speed of the imprint material IM in the contact operation, may be used as the evaluation value. In this embodiment, the example has been described in which one kind of the evaluation value is used, but a plurality of kinds of evaluation values can be used. For example, as the plurality of kinds of evaluation values, the evaluation value concerning the bubble defect density and the evaluation value concerning the position deviation of the pattern transferred to the imprint material IM may be used. Furthermore, when a plurality of indices are set as evaluation functions, a MOTPE method, a method based on a genetic algorithm, or the like may be used.

One or more parameter values are preferably updated such that a constraint condition for restricting the operation of each operation mechanism in the imprint apparatus IMP is satisfied. That is, one or more parameter values are preferably adjusted such that the constraint condition is satisfied. Examples of the constraint condition are the upper limit value of the speed for driving the mold M by the mold driving mechanism 122, the upper limit value of the pressing force applied to the mold M by the mold driving mechanism 122, and the upper limit value of the pressure (cavity pressure) applied to the pressure control space CS by the deformation mechanism 123.

In step S07, the processor 301 determines the control profile based on the adjusted one or more parameter values. More specifically, the control profile is determined by applying, to the control profile, the one or more parameter values adjusted through steps S02 to S06. The control profile determined in step S07 is output from the processor 301 and, for example, can be stored in the memory 302 as a text file describing the control profile. The imprint apparatus IMP performs the imprint process (shaping process) by controlling each operation mechanism using the control profile determined through the flowchart of FIG. 4. With this, generation of shaping defects such as unfilling defects (bubble defects) can be reduced.

As described above, according to this embodiment, a determination method of a control profile used to temporally control an operation mechanism operated in an imprint process is provided. More specifically, a control profile is determined by adjusting one or more parameter values, that define a function representing the control profile, such that an evaluation value concerning the state of the imprint material IM falls within a predetermined range. With this, it is possible to appropriately and easily determine the control profile used in the imprint process. That is, the time and cost required for determination of the control profile can be significantly reduced.

Here, in this embodiment, the determination method of the control profile used in the contact operation of bringing the mold M into contact with the imprint material IM on the substrate S has mainly been described. However, the determination method of the control profile in this embodiment is also applicable to determination of a control profile used in the mold separation operation of separating the mold M from the cured product of the imprint material IM on the substrate S. In addition, in this embodiment, the determination method of the control profile used in the imprint apparatus IMP (imprint process) has been described. However, the determination method of the control profile in this embodiment is also applicable to determination of a control profile used in a planarization apparatus (planarization process).

### <Embodiment of Article Manufacturing Method>

An article manufacturing method according to the embodiment of the present disclosure is suitable for manufacturing an article, for example, a microdevice such as a semiconductor device or an element having a microstructure. The article manufacturing method according to this embodiment includes a shaping step of shaping a composition on a substrate using the above-described shaping method by a shaping apparatus, a processing step of processing the substrate having the composition shaped in the shaping step, and a manufacturing step of manufacturing an article from the substrate processed in the processing step. An imprint apparatus or a planarization apparatus can be used as the shaping apparatus. The manufacturing method further includes other known steps (oxidation, film formation, deposition, doping, planarization, etching, resist removal, dicing, bonding, packaging, and the like). The article manufacturing method of this embodiment is more advantageous than the conventional methods in at least one of the performance, quality, productivity, and production cost of the article.

The pattern of a cured product shaped using the above-described shaping apparatus is used permanently for at least some of various kinds of articles or temporarily when manufacturing various kinds of articles. The articles are an electric circuit element, an optical element, a MEMS, a recording element, a sensor, a mold, and the like. Examples of the electric circuit element are volatile and nonvolatile semiconductor memories such as a DRAM, an SRAM, a flash memory, and an MRAM and semiconductor elements such as an LSI, a CCD, an image sensor, and an FPGA. Examples of the mold are a mold for imprint and a mold (template or superstrate) for planarization.

The pattern of the cured product is directly used as the constituent member of at least some of the above-described articles or used temporarily as a resist mask. After etching or ion implantation is performed in the substrate processing step, the resist mask is removed.

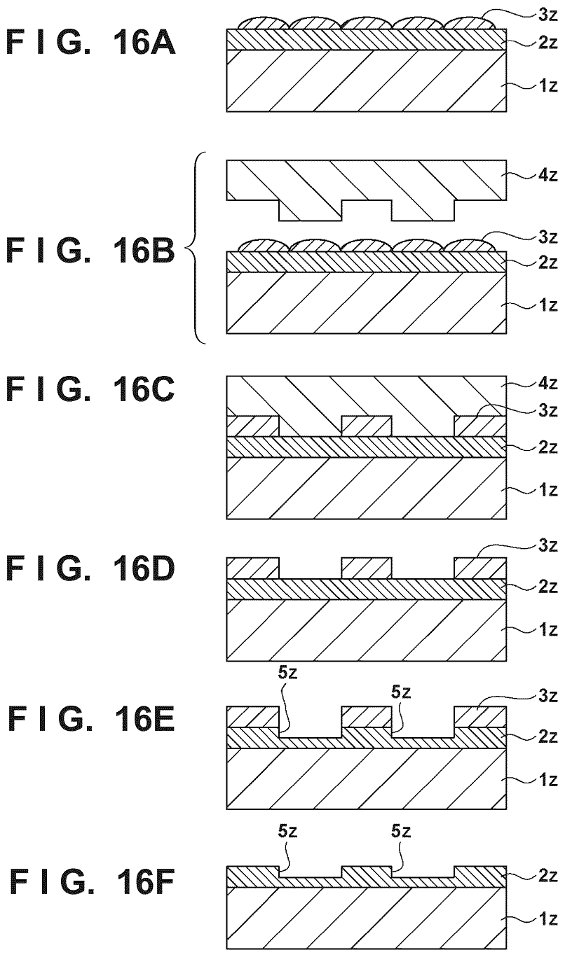

A practical article manufacturing method in a case where an imprint apparatus is used as the shaping apparatus will be described next. As shown FIG. 16A, a substrate 1z such as a silicon wafer with a processed material 2z such as an insulator formed on the surface is prepared. Next, an imprint material 3z is applied to the surface of the processed material 2z by an inkjet method or the like. A state in which the imprint material 3z is applied as a plurality of droplets onto the substrate is shown here.

As shown in FIG. 16B, a side of a mold 4z for imprint with a concave-convex pattern is directed to face the imprint material 3z on the substrate. As shown FIG. 16C, the mold 4z and the substrate 1z to which the imprint material 3z has been applied are brought into contact with each other, and a pressure is applied. The gap between the mold 4z and the processed material 2z is filled with the imprint material 3z. In this state, when the imprint material 3z is irradiated with light as curing energy via the mold 4z, the imprint material 3z is cured.

As shown in FIG. 16D, after the imprint material 3z is cured, the mold 4z is separated from the substrate 1z, and the pattern of the cured product of the imprint material 3z is formed on the substrate 1z. In the pattern of the cured product, the concave portion of the mold corresponds to the convex portion of the cured product, and the convex portion of the mold corresponds to the concave portion of the cured product. That is, the concave-convex pattern of the mold 4z is transferred to the imprint material 3z.

As shown in FIG. 16E, when etching is performed using the pattern of the cured product as an etching resistant mask, a portion of the surface of the processed material 2z where the cured product does not exist or remains thin is removed to form a groove 5z. As shown in FIG. 16F, when the pattern of the cured product is removed, an article with the grooves 5z formed in the surface of the processed material 2z can be obtained. Here, the pattern of the cured product is removed. However, instead of removing the pattern of the cured product after the process, it may be used as, for example, an interlayer dielectric film included in a semiconductor element or the like, that is, a constituent member of an article.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-135035, filed on Aug. 13, 2024, which is hereby incorporated by reference herein in its entirety.

What is claimed is:

1. A determination method of a control profile used to temporally control a mechanism configured to be operated in a shaping process of shaping a composition on a substrate using a mold, the method comprising:
obtaining a processing condition used for the shaping process;
adjusting one or more elements, that define a function representing the control profile using an elapsed time of the shaping process as a variable, such that an evaluation value concerning a state of the composition in a case where the shaping process is performed under the processing condition falls within a predetermined range; and
determining the control profile based on the adjusted one or more elements.

2. The determination method according to claim 1, further comprising obtaining the evaluation value by using a simulation for predicting a behavior of the composition in the shaping process.

3. The determination method according to claim 1, further comprising obtaining the evaluation value by using a result of the shaping process performed on a test substrate.

4. The determination method according to claim 1, wherein the evaluation value is obtained based on at least one of a defect of the composition, a shape of the composition, and a position deviation of a pattern of the composition, which are generated by the shaping process, as a state of the composition.

5. The determination method according to claim 1, wherein the one or more elements include at least one of a coefficient and a constant that define the function.

6. The determination method according to claim 1, wherein the control profile is a profile indicating a temporal driving target value of the mechanism in the shaping process.

7. The determination method according to claim 1, wherein the control profile is represented by one of a linear function, a nonlinear function, an S-shaped function, and a spline function.

8. The determination method according to claim 1, wherein in the adjusting, the one or more elements are adjusted such that a constraint condition for restricting an operation of the mechanism is satisfied.

9. The determination method according to claim 1, wherein
the control profile includes a first section represented by a first function, and a second section represented by a second function different from the first function, and
in the adjusting, one or more elements that define the first function and one or more elements that define the second function are adjusted such that the evaluation value falls within the predetermined range.

10. The determination method according to claim 1, wherein
the shaping process is performed by operating a plurality of kinds of mechanisms, and
for each of the plurality of kinds of mechanisms, the control profile is determined by performing the adjusting and the determining.

11. The determination method according to claim 10, wherein
the type of a function representing the control profile is different among the plurality of kinds of mechanisms, and
in the adjusting, the type of a function representing the control profile is specified in accordance with the kind of a mechanism, and the one or more elements are adjusted for each kind of the mechanism.

12. The determination method according to claim 1, wherein the processing condition includes at least one of a density of a pattern provided in the mold, a depth of a concave portion of the pattern, a thickness of the composition shaped by the shaping process, and an arrangement of the composition supplied as a plurality of droplets onto the substrate.

13. The method according to claim 1, wherein the shaping process is an imprint process of forming a pattern in the composition on the substrate using the mold having a pattern.

14. The method according to claim 1, wherein the shaping process is a planarization process of planarizing the composition on the substrate using the mold having a flat surface.

15. A shaping method comprising:
determining, using a determination method defined in claim 1, a control profile used to temporally control a mechanism configured to be operated in a shaping process of shaping a composition on a substrate using a mold; and
performing the shaping process by controlling the mechanism based on the determined control profile.

16. An article manufacturing method comprising:
shaping a composition on a substrate using a shaping method defined in claim 15;
processing the substrate having the shaped composition, and
manufacturing an article from the processed substrate.

17. An information processing apparatus that determines a control profile used to temporally control a mechanism configured to be operated in a shaping process of shaping a composition on a substrate using a mold, wherein the information processing apparatus is configured to:
obtain a processing condition used for the shaping process;
adjust one or more elements, that define a function representing the control profile using an elapsed time of the shaping process as a variable, such that an evaluation value concerning a state of the composition in a case where the shaping process is performed under the processing condition falls within a predetermined range; and
determine the control profile based on the adjusted one or more elements.

18. A shaping apparatus that performs a shaping process of shaping a composition on a substrate using a mold, comprising:
a mechanism configured to be operated in the shaping process; and
a controller configured to obtain a control profile determined using an information processing apparatus defined in claim 17, and control the mechanism based on the obtained control profile.
